(19) United States
(12) Patent Application Publication
(10) Pub. No.: US 2022/0353223 A1
(43) Pub. Date: Nov. 3, 2022

(54) TEXT COMMAND BASED GROUP LISTENING SESSION PLAYBACK CONTROL

(71) Applicant: Spotify AB, Stockholm (SE)

(72) Inventors: Jérôme CECCATO, Stockholm (SE); Saul Marcelo HERNANDEZ RISHMAWY, Stockholm (SE); Richard Jan TJERNGREN, Stockholm (SE)

(21) Appl. No.: 17/244,064

(22) Filed: Apr. 29, 2021

(51) Int. Cl. H04L 12/58; G06F 40/205; G06F 16/638; G06F 16/683

(52) U.S. Cl. CPC H04L 51/18; G06F 40/205; H04L 51/02; G06F 16/639; G06F 16/683

(57) ABSTRACT

A method of providing a group listening session to users of a messaging platform includes: receiving, at a media streaming platform, a message feed from the messaging platform; parsing, at the media streaming platform, the message feed to identify one or more commands included in the message feed, wherein the one or more commands are associated with the group listening session provided by the media streaming platform; and controlling the group listening session according to the one or more commands, each of the users being associated with a media device for participating in the group listening session.

### BACKGROUND

Media streaming platforms are platforms that provide streaming media. The streaming media are multimedia that are constantly received by and presented to an end user while being delivered by the media streaming platforms. Streaming refers to the process of delivering or obtaining media in a continuous manner from a particular source.

Messaging platforms are platforms that enable instant messaging, VoIP (Voice over IP), and digital distribution and create communities. Users of the messaging platforms communicate with voice calls, video calls, text messaging, media, and files in private chats or as part of communities sometimes called “servers.” Servers are a collection of persistent chat rooms and voice chat channels. A handful of friends can hang out, share, or collaborate at the messaging platform. The messaging platform can also be used by a school study club, a gaming group, a book group, a global art community, and the like.

The integration of a media streaming platform into a messaging platform is desirable.

### SUMMARY

In general terms, this disclosure is related to systems and methods for text command based group listening session playback control.

One aspect can include a method of providing a group listening session to users of a messaging platform. The method includes receiving, at a media streaming platform, a message feed from the messaging platform; parsing, at the media streaming platform, the message feed to identify one or more commands included in the message feed, wherein the one or more commands are associated with the group listening session provided by the media streaming platform; and controlling the group listening session according to the one or more commands, each of the users being associated with a media device for participating in the group listening session.

In another aspect, a system includes a plurality of media devices and a media streaming platform. Each media device is associated with a user. The media streaming platform provides the users with a group listening session and is configured to: receive a message feed, the message feed including one or more commands received from the users, the one or more commands configured to control the group listening session; parse the message feed to identify the one or more commands; and control the group listening session according to the one or more commands.

In yet another aspect, a non-transitory computer-readable medium can include instructions that, when executed by a processor, cause the processor to: receive, at a media streaming platform, a message feed from the messaging platform; parse, at the media streaming platform, the message feed to identify one or more commands included in the message feed, wherein the one or more commands are associated with the group listening session provided by the media streaming platform; and control the group listening session according to the one or more commands, each of the users being associated with a media device for participating in the group listening session.

### BRIEF DESCRIPTION OF THE DRAWINGS

FIG. 1 illustrates an example system for text command based group listening session playback control.

FIG. 2 illustrates the interaction between the media device of FIG. 1 and the messaging platform of FIG. 1.

FIG. 3 illustrates an example messaging platform user interface of FIG. 2 and an example visualization of the media-playback engine of FIG. 2 at a first moment.

FIG. 4 illustrates the interaction between the media device of FIG. 1 and the media streaming platform of FIG. 1.

FIG. 5 illustrates an example initialization flow for the text command based group listening session playback control.

FIG. 6 illustrates an example messaging platform user interface of FIG. 2 and an example visualization of the media-playback engine of FIG. 2 at a second moment.

FIG. 7 illustrates an example process for the text command based group listening session playback control carried out by the system of FIG. 1.

FIG. 8 illustrates a method of text command based group listening session playback control.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

A group listening session is a function provided by a media streaming platform that allows multiple people who are not necessarily in close proximity to one another to join with others at the same time in a virtual group to enjoy the same streaming media. In one embodiment, the streaming media are audio streaming media, including but not limited to, a stream of music tracks, a stream of podcast tracks, a stream of both music tracks and podcast tracks, and the like. In another embodiment, the streaming media are video streaming media, which can include audio. No matter the distance, whether six feet apart or a thousand miles away, members of a group listening session can each tune into the same media content at the same time.

For instance, a girl in Los Angeles can listen to the same playlist with her boyfriend in New York City at the same time, and both can create, control, or edit the shared playlist. In another example, a user in Miami can host a virtual country cookout session with his mom in Dallas and his brother in Houston. In yet another example, friends in Boston, San Francisco, and London can coordinate a morning-noon-night group jog and keep the same pace across time zones with a running motivation playlist. In yet another example, a group of electronic sports (esports) gamers in a team or a club can sit in a gaming room and control a playlist played at the same speaker, which is connected to their individual computers.

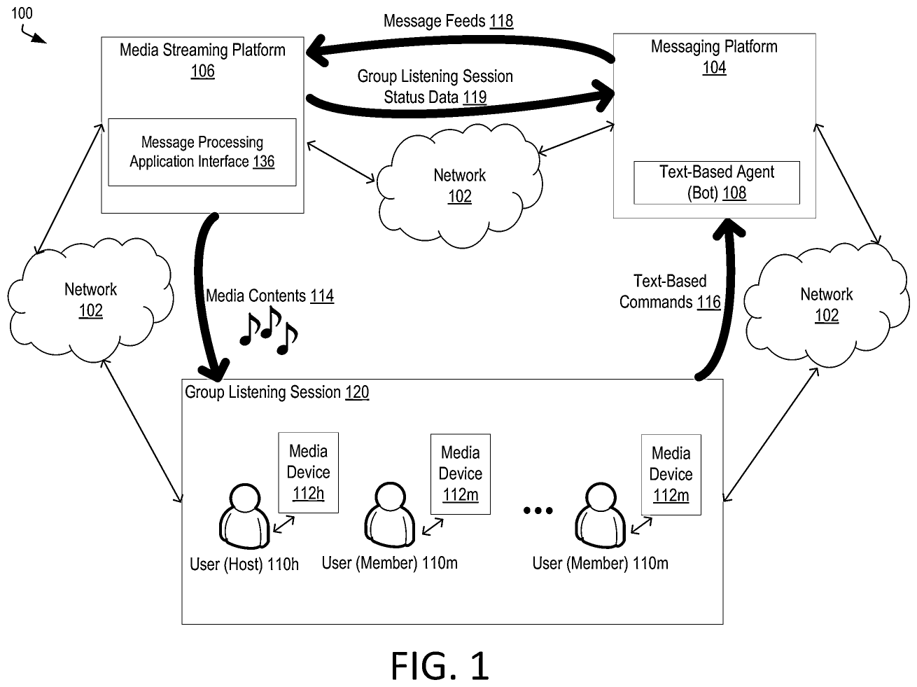

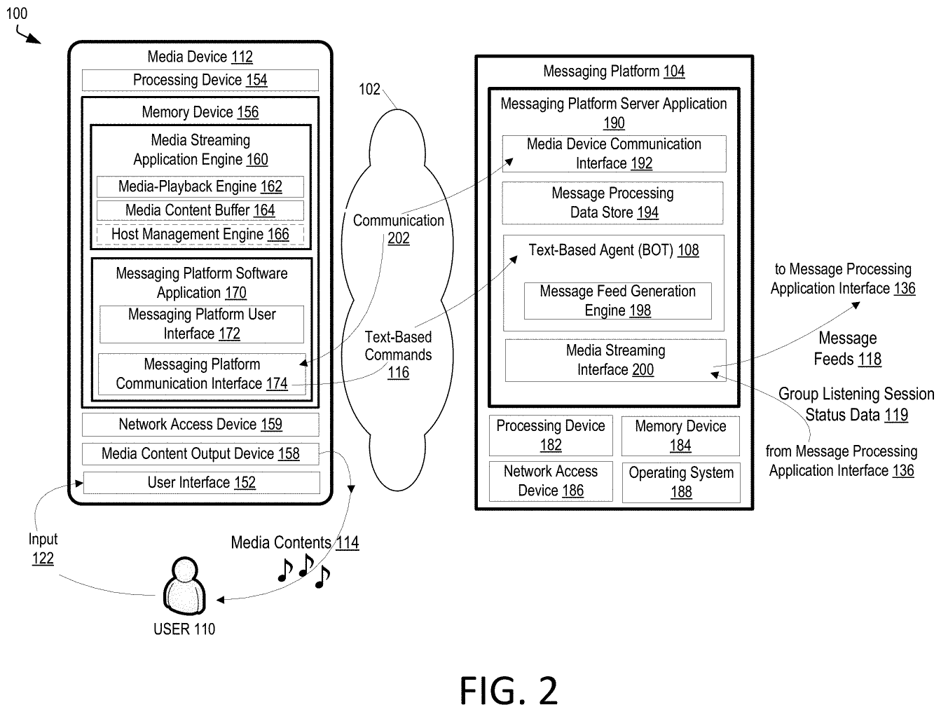

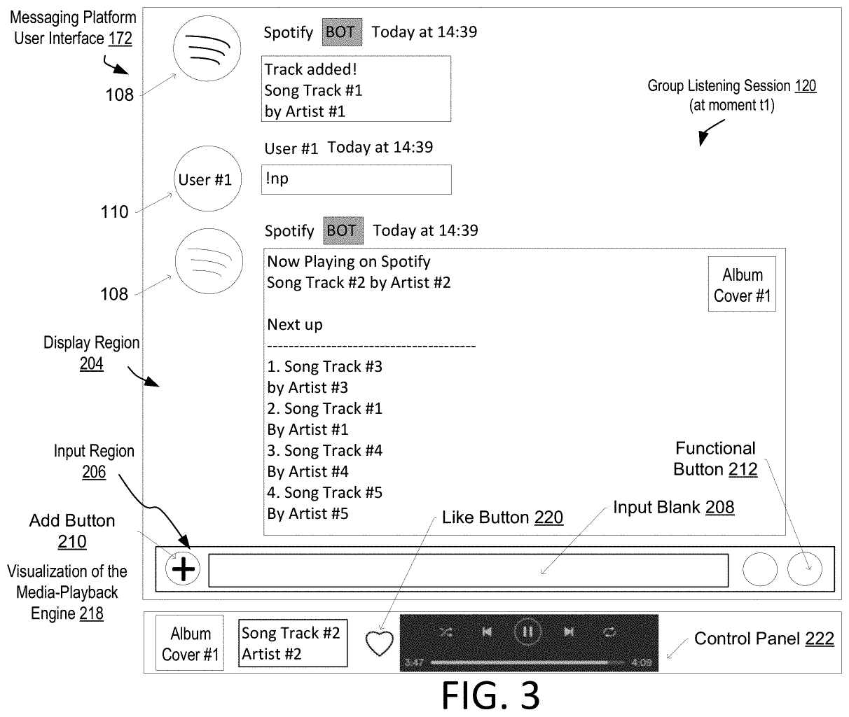

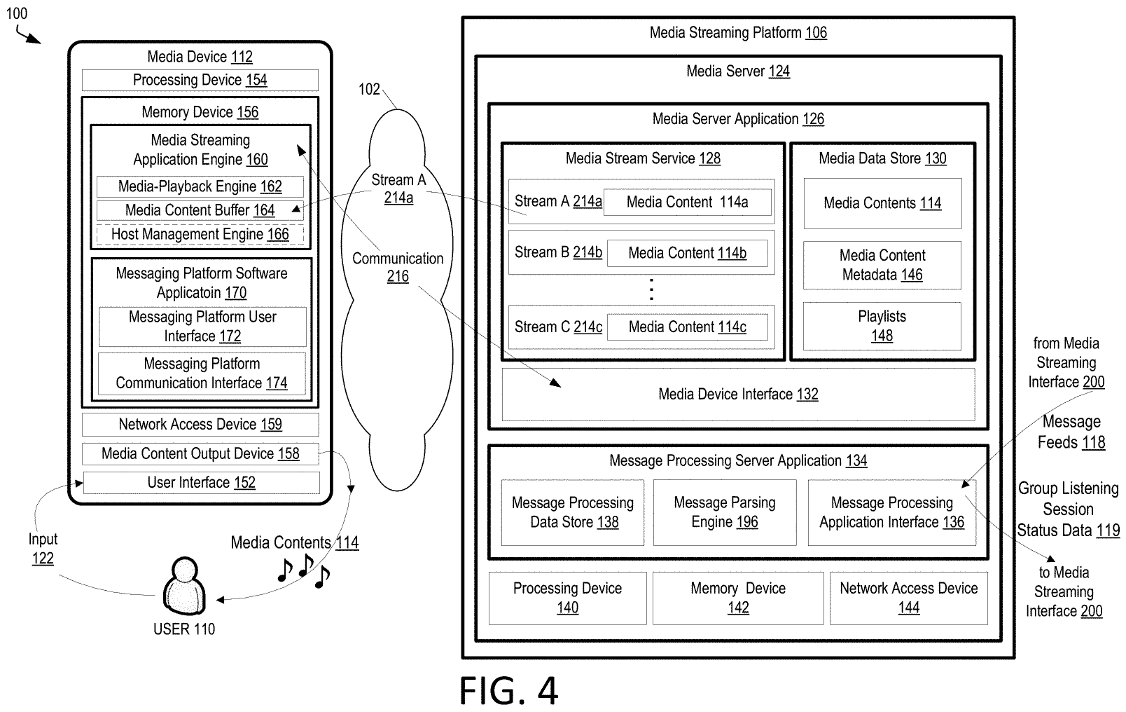

FIG. 1 illustrates an example system 100 for text command based group listening session playback control. FIG. 2 illustrates the interaction between the media device 112 of FIG. 1 and the messaging platform 104 of FIG. 1. FIG. 3 illustrates an example messaging platform user interface 172 of FIG. 2 and an example visualization of the media-playback engine 218 of FIG. 2 at a first moment. FIG. 4 illustrates the interaction between the media device 112 of FIG. 1 and the media streaming platform 106 of FIG. 1.

In the example of FIG. 1, the system 100 includes, among other things, a group listening session 120, a messaging platform 104, a media streaming platform 106, and a network 102. The group listening session 120 includes, among other things, a user (host) 110h who is the host of the group listening session 120 and a number of users (members) 110m who are non-host members of the group listening session 120. The user (host) 110h and the users (members) 110m are collectively called users 110.

In the example shown in FIG. 1, the user (host) 110h has a media device 112h, whereas each of the users (members) 110m has a media device 112m. In other words, each user 110 has his or her own media device (collectively, media device 112). The media device 112, operating as a client device, can receive and play media contents 114 delivered by the media streaming platform 106. In some embodiments, the users 110 may share one or more media devices 112, and the playback statuses of the group listening session 120 at the shared media devices 112 can be controlled by the users 110 together accordingly. In some embodiments, the media devices 112 can be, for example, personal computer systems, handheld entertainment devices, tablet devices, smartphones, smart televisions, audio speakers, in-car entertainment systems, or other type of electronic or media devices that are adapted or able to receive and play media contents 114 delivered by the media streaming platform 106.

The network 102 is an electronic communication network that facilitates communication between two or more components of the system 100. In some embodiments, the network 102 is a local area network, peer-to-peer connection, wireless or cellular network, or other forms of network.

Each media device 112 has both a messaging platform software application 170 corresponding to the messaging platform 104 and a media streaming application engine 160 corresponding to the media streaming platform 106 installed on his or her media device 112, details of which will be described below with reference to FIG. 2 and FIG. 4.

In general, each user 110 is able to use his or her media device 112 to send text-based commands 116 to a text-based agent (also referred to as bot) 108 of the messaging platform 104. The text-based agent 108 is software application used to conduct an online chat conversation via text or text-to-speech, in lieu of providing direct contact with a live human agent. In some implementations, the text-based agent 108 may scan for general keywords and generate responses using common phrases obtained from an associated library or database. In some implementations, the text-based agent 108 may use extensive word-classification processes, natural language processing (NLP), and artificial intelligence (AI). The messaging platform 104 generates message feeds 118 based on the text-based commands 116 and sends the message feeds 118 to the media streaming platform 106 through a messaging processing application interface 136. The media streaming platform 106 then parse the message feeds 118 to identify the text-based commands 116 included in the message feeds 118. Based on the identified text-based commands 116, the media streaming platform 106 delivers the media contents 114 to the group listening session 120 accordingly and controls the group listening session 120. In the meantime, the media streaming platform 106 sends group listening session status data 119 to the messaging platform 104, which could be passed along to the media device 112 to be displayed on the messaging platform user interface 172. The group listening session status data 119 is data related to the status of the group listening session 120. In some embodiments, the group listening session status data 119 can include, among other things, the identification of the group listening session 120, the participants (i.e., the user (host) 110h and the users (member) 110m) of the group listening session 120, associated media devices 112h and 112m and the online/offline statuses thereof, the timing of the group listening session 120, the media content item currently being streamed, the playback position of the media content item currently being streamed, metadata around the media content item currently being streamed. As such, any one of the user (host) 110h and the users (members) 110m is able to control the group listening session 120 using text-based commands 116 and via the messaging platform 104. The messaging platform 104, the media streaming platform 106, and the media devices 112 are synchronized as to the status of the group listening session 120. The users 110 can simply control the group listening session 120 “within” the messaging platform 104 by interacting with the bot 108, without feeling the instruction/data flow between the media streaming platform 106 and the messaging platform and the instruction/data flow between the media streaming platform 106 and his or her media device 112. Thus, the users 110 can enjoy both the group listening session 120 provided by the media streaming platform 106 and the social network service provided by the messaging platform 104 simultaneously, without the need to switch between the messaging platform software application 170 for the messaging platform 104 and the media streaming application engine 160 for the media streaming platform 106 to control the group listening session 120 and the social network service, respectively. It should be noted that the text-based commands 116 may, in some embodiments, be the output of a voice or speech recognition system, which enables the recognition and translation of spoken language into text. The voice or speech recognition system may be communicatively coupled to the media devices 112.

As mentioned above, the users 110, in some embodiments, may share one or more media devices 112, and the playback statuses of the group listening session 120 at the shared media devices 112 can be controlled by the users 110 together accordingly. In one implementation, playback commands from multiple users 110 can be buffered for later execution. The command buffer logic may execute the playback commands in sequence or in a stack machine architecture (i.e., first in but last out). In another implementation, the user (host) 110h may elect which of the playback commands received from multiple users 110 to be executed. The election may be triggered in some predetermined situations, such as when a track is to be skipped and when scrubbing by a user 110 exceeds a predefined amount of time.

As shown in FIG. 2, the media device 112 includes, among other things, a processing device 154, a memory device 156, a network access device 159, a media content output device 158, and a user interface 152.

In an example, the processing device 154 includes one or more central processing units (CPU). In other embodiments, the processing device 154 additionally or alternatively includes one or more digital signal processors, field-programmable gate arrays, or other electronic circuits.

The memory device 156 operates to store data and instructions. In some embodiments, the memory device 156 stores instructions and data on both the messaging platform 104 and the media streaming platform 106. In other words, the messaging platform software application 170 for the messaging platform 104 and the media streaming application engine 160 for the media streaming platform 106 are both stored in the memory device 156.

The network access device 159 operates to communicate with other components of the system 100 over the networks, such as the network 102. Examples of the network access device 159 include one or more wired network interfaces and wireless network interfaces. Examples of such wireless network interfaces of the network access device 159 include wireless wide area network (WWAN) interfaces (including cellular networks) and wireless local area network (WLANs) interfaces. In other examples, other types of wireless interfaces can be used for the network access device 102.

The media content output device 158 operates to output media contents 114. In some embodiments, the media content output device 158 generates media content output visually and/or audibly for the user 110. Examples of the media content output device 158 include a speaker assembly comprising one or more speakers, an audio output jack, a Bluetooth® transmitter, a display panel, and a video output jack. Other embodiments are possible as well. For example, the media content output device 158 may transmit a signal through the audio output jack or Bluetooth® transmitter that can be used to reproduce an audio signal by a connected or paired device such as headphones or a speaker system.

The user interface 152 is the one or more components of the media device 112 over which the user 110 and the media device 112 can interact unidirectionally or bidirectionally. The user interface 152 can include, for example, a touch screen that can display data to the user 110 and receive input 122 from a selector (e.g., a finger, stylus, etc.) controlled by the user 110. The user interface 152 can include, for example, a display device, a mouse, a keyboard, a webcam, a microphone, speakers, a headphone, haptic feedback devices, or other components.

The messaging platform software application 170 is software installed in the memory device 156 for using the social media services provided by the messaging platform 104. The messaging platform software application 170 includes, among other things, the messaging platform communication interface 174 and the messaging platform user interface 172.

The messaging platform communication interface 174 operates to serve as an interface over which the messaging platform software application 170 and the messaging platform 104 can communicate unidirectionally or bidirectionally over the network 102. In the example of FIG. 2, the messaging platform communication interface 174 may communicate with the messaging platform 104 to facilitate the communication 202 and the delivery of the text-based commands 116.

The messaging platform user interface 172 is a user interface over which the user 110 and the messaging platform 104 can interact unidirectionally or bidirectionally. In one embodiment, the messaging platform user interface 172 can take advantage of the resources of the user interface 152, such as the touch screen that can display data to the user 110 and receive input 122 from a selector controlled by the user 110. In another embodiment, the messaging platform user interface 172 may include its own resources such as a display device, a mouse, a keyboard, a webcam, a microphone, speakers, a headphone, haptic feedback devices, or other components. An example messaging platform user interface 172 is illustrated in FIG. 3 and will be described in detail below.

The media streaming application engine 160 is software installed in the memory device 156 for using the media streaming services, including the group listening session 120, provided by the media streaming platform 106. Details of the media streaming application engine 160 and its components will be described in detail below with reference to FIG. 4.

The messaging platform 104 includes, among other things, a processing device 182, a memory device 184, a network access device 186, an operating system 188, and a messaging platform server application 190. The processing device 182, the memory device 184, and the network access device 186 may provide similar functionality as the processing device 154, the memory device 184, and the network access device 159 and, therefore, are not repeated for simplicity.

The operating system 188 operates to support the execution of the messaging platform server application 190 that can be used, for example, to provide messaging social network services to users or subscribers of the messaging platform 104. The messaging social network services include, but not limited to, create text-based channels, join text-based channels, share text-based channels, create voice-based channels, join voice-based channels, share voice-based channels.

In this example, the messaging platform server application 190 includes, among other things, a media device communication interface 192, a message processing data store 194, the text-based agent (bot) 108, and the media streaming interface 200. In some embodiments, the bot 108 includes the message feed generation engine 198, while in other embodiments the message feed generation engine 198 is a separate component of the messaging platform server application 190.

The media device communication interface 192 is a counterpart of the messaging platform communication interface 174. The media device communication interface 192 operates to serve as an interface over which the messaging platform software application 170 and the messaging platform 104 can communicate unidirectionally or bidirectionally over the network 102. In the example of FIG. 2, the media device communication interface 192 may communicate with the messaging platform software application 170 to facilitate the communication 202 and the delivery of the text-based commands 116.

The message processing data store 194 may store information related to messages or message processing. The information can include, for example, a list of permitted senders, a list of blocked message senders, frequent requests, valid requests, request syntaxes or patterns, and other information.

The bot 108 operates to interact with the users 110 for controlling the group listening session 120. The bot 108 receives the text-based commands 106 and may act in accordance with a bot conversation logic to provide the users 110 with the access to the media streaming platform 106. Depending on how the bot 108 is configured, it can act in a reactive manner, awaiting an input from any of the users 110, or can act proactively, sending messages to the users 110 in the manner of a push-notification. In one example, the bot 108 is implemented at a server at the same domain of the media streaming platform 106. In another example, the bot 108 is implemented at a server at the same domain of the messaging platform 104. In yet another example, the bot 108 is implemented at a server different from the media streaming platform 106 and the messaging platform 104.

The message feed generation engine 198 operates to generate message feeds 118 based on the text-based commands 116 received by the bot 108. In one embodiment, a message feed 118 may include multiple text-based commands 116 from multiple users 110. In another embodiment, a message feed 118 may include one text-based command 116 from one of the multiple users 110.

The media streaming interface 220 operates to serve as an interface over which the messaging platform 104 and the media streaming platform 106 can communicate with each other. Specifically, the media streaming interface 220 teams up with its counterpart, the message processing application interface 136 at the media streaming platform 106, to exchange the message feeds 118 and the group listening session status data 119. The group listening session status data 119 received by the media streaming interface 200 can be sent to the messaging platform user interface 172.

As shown in FIG. 3, an example messaging platform user interface 172 and an example visualization of the media-playback engine 218 are displayed on, for example, the user interface 152 of the media device 112. The messaging platform user interface 172 has a display region 204 and an input region 206. The input region 206 is where the user 110 can interact with the media device 112 to input text-based commands 116 in an input blank 208. In the example of FIG. 3, an add button 210 and one or more functional buttons 212 can be used to add other contents (e.g., invitation to join the group listening session 120, files to be uploaded, emojis, Graphics Interchange Formats (GIFs), and the like).

In the display region 204, the group listening session 120 is going on, and the current status at the moment t1 is shown in the display region 204. The bot 108 shows a Song Track #1 by Artist #1 has been added to a queue. Then User #1 sends a text-based command 116 (i.e., “!np”) to inquire about the song track currently playing. In this example, the syntax of the text-based command 116 includes a command indicator “!” immediately followed by the parameter “np,” which means “now playing.” It should be noted that other syntaxes are also within the scope of the disclosure. After the bot 108 receives the text-based command 116, the message feed generation engine 198 generates the message feed 118. The media streaming interface 200 sends the message feed 118 to the message processing application interface 136 and subsequently receives the group listening session status data 119. As a result, in a non-limiting example, the bot 108 outputs the currently playing song track, which is Song Track #2 by Artist #2 with its Album Cover #1. The output track related information is not limited to the aforementioned ones. Other song tracks in the queue are also shown below. As such, the users 110 can interact with the bot 108 to control the group listening session 120.

On the other hand, the visualization of the media-playback engine 218 is also shown at the bottom simultaneously. The visualization of the media-playback engine 218 includes the currently playing song track, which is Song Track #2 by Artist #2 with its Album Cover #1. A like button 220 and a control panel 222 are also shown. It should be noted that the visualization of the media-playback engine 218 is simply illustrative, and other visualization manners are within the scope of the disclosure.

As shown in FIG. 4, the media device 110 includes the media streaming application engine 160, which is software installed in the memory device 156 for using the media streaming services, including the group listening session 120, provided by the media streaming platform 106. The media streaming application engine 160 includes, among other things, a media-playback engine 162, a media content buffer 164, and optionally a host management engine 166.

The media-playback engine 162 selects and plays back media contents 114, generates interfaces for controlling and playing media contents 114. The media content buffer 164 operates to serve as a client-side buffer that can be used to control the playback of the media contents 114 received from the media streaming platform 104. The host management engine 166 is used when the user 110 of the media device 112 is a user (host) 110h. The host management engine 166 may facilitate the host functions carried out by the user (host) 110h, including, for example, initiating the group listening session 120, terminating the group listening session 120, transferring the host privilege of the group listening session 120, and the like.

The media streaming platform 104 includes a media server 124. The media server 124 includes, among other things, a processing device 140, a memory device 142, a network access device 144, a messaging processing server application 134, and a media server application 126. The processing device 140, the memory device 142, and the network access device 144 may provide similar functionality as the processing device 154, the memory device 184, and the network access device 159 and, therefore, are not repeated for simplicity.

The message processing server application 134 further includes, among other things, the message processing application interface 136, a message parsing engine 196, and a message processing data store 138. The message processing application interface 136, as described above, is a counterpart of the media streaming interface 200, and both facilitate the exchange of the message feeds 118 and the group listening session status data 119 between the messaging platform 104 and the media streaming platform 106.

The messaging parsing engine 196 operates to identify one or more text-based commands 116 included in the message feeds 118. The messaging parsing engine 196 may analyze the message feeds 118, either in natural language, computer languages or data structures, and conform to the rules of specified syntaxes. In one embodiment, the messaging parsing engine 196 may identify the text-based commands 116 based on specified syntaxes, such as “!np” as described above. Any message feeds 118 and identified text-based commands 116 may be saved in the message processing data store 138 temporarily. Specified syntaxes and newly created syntaxes may also be saved in the message processing data store 138.

The media server application 126 includes a media device interface 132, a media data store 130, and a media stream service 128. The media device interface 132 operates to serve as an interface over which the media streaming platform 104 can communicate with the media streaming application engine 160 at the media device 112. In the example of FIG. 4, the media device interface 132 may communicate with the media streaming application engine 160 to facilitate communication 216.

In the example of FIG. 4, the media data store 130 may store media contents 114, media content metadata 146, and playlists 148, though other categories of data may also be stored thereon. The media data store 130 may comprise one or more databases and file systems.

The media content metadata 146 operates to provide various information associated with the media contents 114. In some embodiments, the media content metadata 146 includes one or more of title, artist name, album name, length, genre, mood, era, and other information. The playlists 148 operate to identify one or more of the media contents 114. In some embodiments, the playlists 148 identify a group of the media contents 114 in a particular order. In other embodiments, the playlists 148 merely identify a group of the media contents 114 without specifying a particular order. Some, but not necessarily all, of the media contents 114 included in a particular one of the playlists 148 are associated with a common characteristic such as a common genre, mood, or era. The playlists 148 may include user-created playlists, which may be available to a particular user, a group of users, or to the public.

The media stream service 128 operates to buffer media contents such as media contents 114a, 114b, and 114c, for streaming to one or more streams 214a, 214b, and 214c. In the example of FIG. 4, the media content 114a is currently being streamed to the media device 112 through one stream 214a (i.e., “Stream A”).

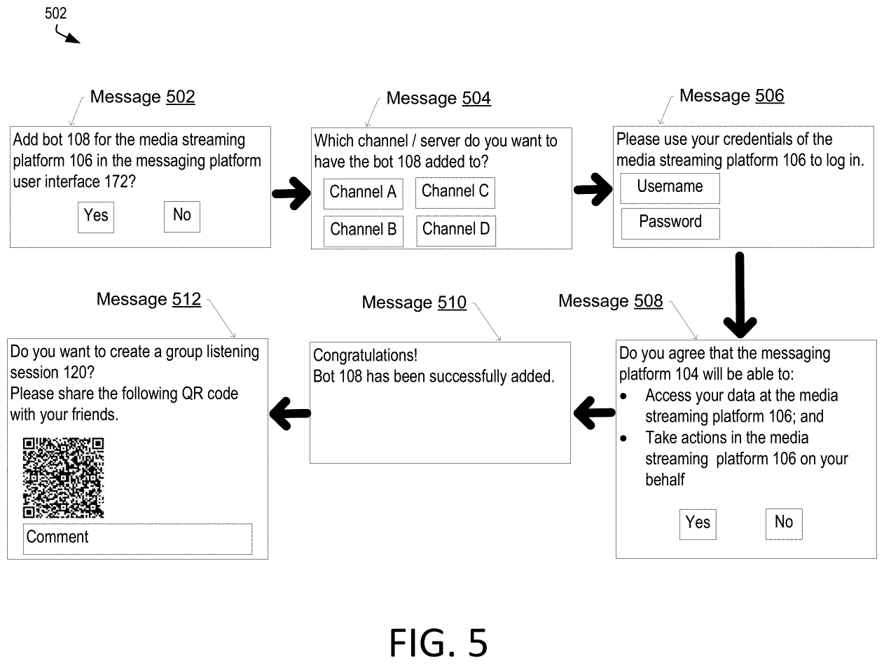

FIG. 5 illustrates an example initialization flow 502 for the text command based group listening session playback control. In general, a user 110 needs to be both a user of the messaging platform 104 and a user of the media streaming platform 106, in order to utilize the text command based group listening session playback control based on the system 100 of FIG. 1. The messaging platform 104 and the media streaming platform 106 must maintain a table to correlate the user identifications (IDs) for both platforms associated with the same user. For example, a user ID for the messaging platform 104 (e.g., User ID: “ABC.messaging”) is corresponding to a user ID for the media streaming platform 106 (e.g., User ID: “ABC.streaming”). When in use, both the messaging platform software application 170 and the media streaming application engine 160 needs to be in an active state with the user 110 logged in at the media device 112.

As shown in the example of FIG. 5, the initialization flow 502 starts with a message 502. The user 110 is asked, in the messaging platform user interface 174, whether he or she wants to add a bot 108 for the media streaming platform 106. If the user 110 selects “Yes,” the initialization flow 502 proceeds to a message 504. The user 110 is then asked which channel/server he or she wants to have the bot 108 added to. The user 110 could select one or more of the channels displayed (e.g., both Channel B and Channel D). The initialization flow 502 then proceeds to a message 506, where the user 110 uses his or her credentials (e.g., both username and password) of the media streaming platform 106 to log in. The initialization flow 502 then proceeds to a message 508. The user 110 is asked whether he or she agrees that the messaging platform 104 will be able to access his or her data at the media streaming platform 106 and take actions in the media streaming platform 106 on his or her behalf. If the user 110 selects “Yes,” the initialization flow 502 proceeds to a message 510. The message 510 displays “Congratulations! Bot 108 has been successfully added.” The initialization flow 502 then proceeds to a message 512, where the user is asked whether he or she wants to create a group listening session 120. If the user 110 chooses so, there is a QR code ready to be shared with his or her friends, and additional comments could be included as well. Alternatively, the user 110 could send invitations to his or her friends via email addresses, usernames in the messaging platform 104, a link such as a URL (Uniform Resource Locator), or the like. As such, the account of the messaging platform 104 and the account of the media streaming platform 106 for the same user 110 have been “linked.”

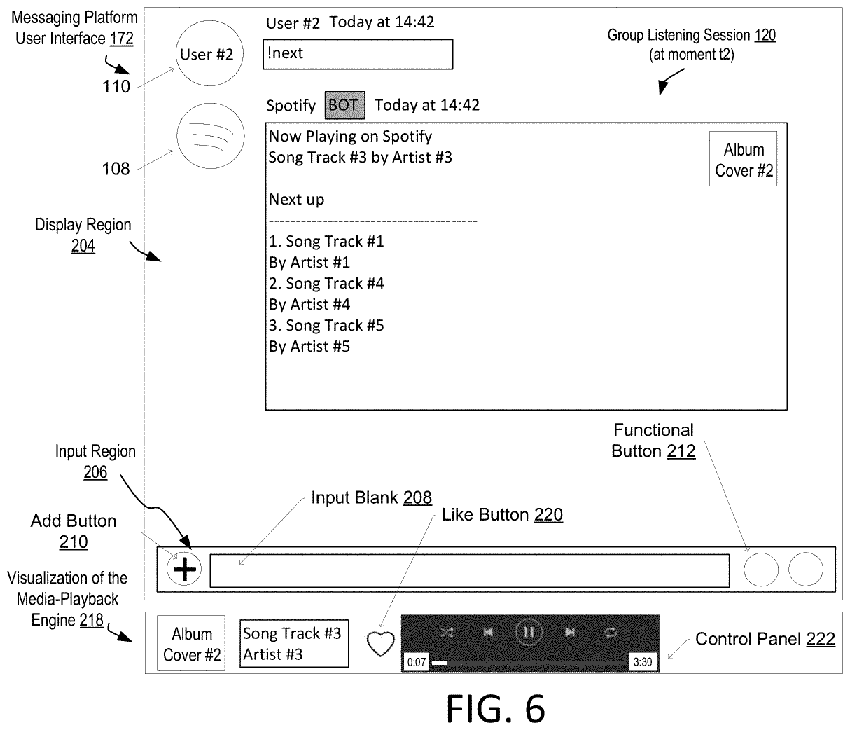

FIG. 6 illustrates an example messaging platform user interface 172 of FIG. 2 and an example visualization of the media-playback engine 218 of FIG. 2 at a second moment. At the moment t2 subsequent to the moment t1 of FIG. 3, another user, User #2 of the group listening session 120, sends a new text-based command 116 (i.e., “!next”) to skip to the next song track in the queue. In this example, the syntax of the text-based command 116 includes the same command indicator “!” immediately followed by the parameter “next,” which means “skip to next in the queue.” It should be noted that other syntaxes are also within the scope of the disclosure.

Examples of syntaxes of the text-based commands 116 may include the following: (i) “!pause” meaning to pause the playback for all the users 110 in the group listening session 120; (ii) “!resume” meaning to resume the playback; (iii) “!shuffle” meaning to shuffle the queue or playlist; (iv) “!repeat” meaning to enable repeat function; (v) “!help” meaning to show all available commands; (vi) “!leave” meaning to leave the group listening session 120; (vii) “!q” meaning to add a new media content to the queue; and (viii) “!play <keyword(s)>” meaning to play one or more search results of media contents 114 that best match the keywords. It should be noted that other syntaxes of the text-based commands 116 are within the scope of the disclosure.

Likewise, after the bot 108 receives the text-based command 116, the message feed generation engine 198 generates the message feed 118. The media streaming interface 200 sends the message feed 118 to the message processing application interface 136 and subsequently receives the group listening session status data 119. As a result, the bot 108 outputs the currently playing song track, which now is Song Track #3 by Artist #3 with its Album Cover #2. Other song tracks in the queue are also shown below. As such, another user, User #2 of the group listening session 120, can jump in and interact with the bot 108 to control the group listening session 120, even though he or she may not be the host.

Likewise, the visualization of the media-playback engine 218 is also updated at the bottom simultaneously. The visualization of the media-playback engine 218 includes the currently playing song track, which is Song Track #3 by Artist #3 with its Album Cover #2. The control panel 222 is updated as well.

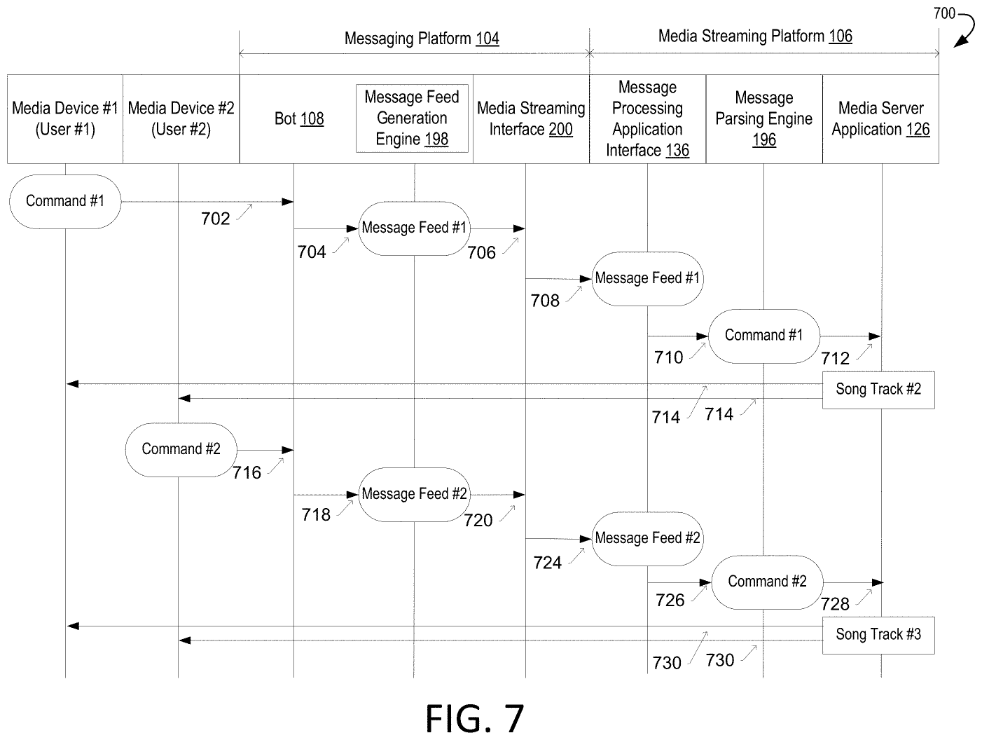

FIG. 7 illustrates an example process 700 for the text command based group listening session playback control carried out by the system 100 of FIG. 1. The example process 700 is corresponding to the examples of FIG. 3 and FIG. 6. Details that have been described above will not be repeated for simplicity.

At step 702, a text-based command #1 (e.g., “!np” of FIG. 3) is sent to the bot 108 by the media device #1 associated with user #1. The bot 108 forwards the text-based command #1 to the message feed generation engine 198 at step 704. The message feed generation engine 198 then generates a message feed #1 and sends it to the media streaming interface 200 at step 706. At step 708, the media streaming interface 200 forwards the message feed #1 to the message processing application interface 136, which is subsequently passed along to the message parsing engine 196 at step 710. At step 712, the message parsing engine 196 identifies the text-based command #1 and sends it to the media server application 126. Eventually, at step 714, the media server application 126 controls the group listening session 120 based on the text-based command #1.

Subsequently, another text-based command #2 (e.g., “!next” of FIG. 6) is sent to the bot 108 by the media device #2 associated with user #2, at step 716. The bot 108 forwards the text-based command #2 to the message feed generation engine 198 at step 718. The message feed generation engine 198 then generates a message feed #2 and sends it to the media streaming interface 200 at step 720. At step 724, the media streaming interface 200 forwards the message feed #2 to the message processing application interface 136, which is subsequently passed along to the message parsing engine 196 at step 726. At step 728, the message parsing engine 196 identifies the text-based command #2 and sends it to the media server application 126. Eventually, at step 730, the media server application 126 controls the group listening session 120 based on the text-based command #1. As such, both user #1 and user #2 are able to control the group listening session 120 using the system 100 of FIG. 1. Eventually at step 730, the media server application 126 controls the group listening session 120 based on the text-based command #1. As such, both user #1 and user #2 are able to control the group listening session 120 using the system 100 of FIG. 1.

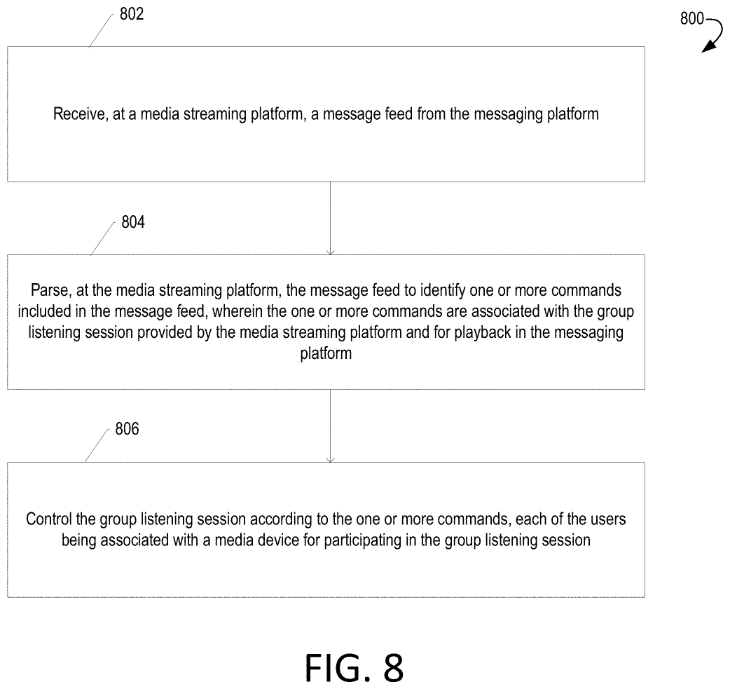

FIG. 8 illustrates a method 800 of text command based group listening session 120 playback control. At operation 802, a message feed 118 from the messaging platform 104 is received at a media streaming platform 106. At operation 804, the message feed 118 is parsed, at the media streaming platform 106, to identify one or more (text-based) commands 116 included in the message feed 118. The one or more (text-based) commands 116 are associated with the group listening session 120 provided by the media streaming platform 106. The group listening session 120 can be controlled by the users through the messaging platform 104. At operation 806, the group listening session 120 is controlled according to the one or more (text-based) commands 116. Each of the users 110 is associated with a media device 112 for participating in the group listening session 120.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory storage medium or computer readable medium (media) having instructions stored thereon/in which can be used to program a computer to perform any of the processes of the present invention. Examples of the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method of providing a group listening session to users of a messaging platform, comprising:
receiving, at a media streaming platform, a message feed from the messaging platform;
parsing, at the media streaming platform, the message feed to identify one or more commands included in the message feed, wherein the one or more commands are associated with the group listening session provided by the media streaming platform; and
controlling the group listening session by updating group listening session status data according to the one or more commands, each of the users being associated with a media device for participating in the group listening session; and
sending, by the media streaming platform, the group listening session status data to the messaging platform and each of the media devices in order to synchronize the media streaming platform, the messaging platform, and each of the media devices to a status of the group listening session,
wherein the group listening session status data includes participants of the group session.

2. The method of claim 1, wherein the one or more commands are text-based commands.

3. The method of claim 1, further comprising:
requesting, by the messaging platform, the users to provide credentials of the media streaming platform to initialize the group listening session.

4. The method of claim 1, wherein both the messaging platform and the media streaming platform are logged in for each media device associated with each of the users during the group listening session.

5. The method of claim 1, further comprising:
inputting by the users, at a text-based agent (bot) located at the messaging platform, the one or more commands.

6. (canceled)

7. The method of claim 1, further comprising:
playing a play queue in the group listening session, the play queue comprising a plurality of media contents.

8. The method of claim 7, wherein the plurality of media contents are song tracks.

9. The method of claim 7, wherein the plurality of media contents are podcasts.

10. The method of claim 7, wherein the one or more commands comprising a creation command configured to create the group listening session.

11. The method of claim 7, wherein the one or more commands comprising an inquiry command configured to display a media content currently playing.

12. The method of claim 7, wherein the one or more commands comprising a queuing up command configured to add a new media content to the play queue.

13. The method of claim 7, wherein the one or more commands comprising a shuffle command configured to shuffle the plurality of media contents.

14. The method of claim 7, wherein the one or more commands comprising a help command configured to display instructions to the one or more commands.

15. A system comprising:
a plurality of media devices, each media device being associated with a user;
a media streaming platform providing the users with a group listening session, the media streaming platform including at least one processing device and at least one memory device, the at least one memory device storing instructions which when executed by the at least one processing device cause the media streaming platform to:
receive a message feed from a messaging platform, the message feed including one or more commands received from the users, the one or more commands configured to control the group listening session;
parse the message feed to identify the one or more commands; and
control the group listening session by updating group listening session status data according to the one or more commands; and
send the group listening session status data to the messaging platform and each of the plurality of media devices in order to synchronize the media streaming platform, the messaging platform, and each of the plurality of media devices to a status of the group listening session,
wherein the group listening session status data includes participants of the group session.

16. The system of claim 15, wherein the one or more commands are text-based commands.

17. (canceled)

18. The system of claim 17, wherein the instructions further cause the media streaming platform to:
initialize the group listening session by allowing the users to provide credentials of the media streaming platform to the messaging platform.

19. The system of claim 17, wherein the plurality of media devices are configured to:
send, to a text-based agent (bot) located at the messaging platform, the one or more commands.

20. A non-transitory computer-readable medium storing instructions that, when executed by a processor, cause the processor to:
receive, at a media streaming platform, a message feed from the messaging platform;
parse, at the media streaming platform, the message feed to identify one or more commands included in the message feed, wherein the one or more commands are associated with the group listening session provided by the media streaming platform; and
control the group listening session by updating group listening session status data according to the one or more commands, each of the users being associated with a media device for participating in the group listening session; and
send, by the media streaming platform, the group listening session status data to the messaging platform and each of the media devices in order to synchronize the media streaming platform, the messaging platform, and each of the media devices to a status of the group listening session,
wherein the group listening session status data includes participants of the group session.

21. The method of claim 1, wherein the group listening session status data includes identification of media devices associated with the participants of the group session.

22. The method of claim 21, wherein the group listening session status data includes the online/offline status of the media devices associated with the participants of the group session.
